(19) United States
(12) Patent Application Publication
(10) Pub. No.: US 2006/0231187 A1
(43) Pub. Date: Oct. 19, 2006

(54) Method and apparatus for bonding workpieces

(75) Inventor: Shih-Chieh Yen, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/361,619

(22) Filed: Feb. 24, 2006

(30) Foreign Application Priority Data
Apr. 15, 2005 (CN) 200510034250.8

(51) Int. Cl. B31B 1/60

(52) U.S. Cl. 156/60

(57) ABSTRACT

An apparatus (100) for bonding workpieces (17) includes a first container (10), a second container (12), a transferring mechanism (106), and a bonding agent supplier (16). The first container is for containing pre-bonding workpieces. The first container has a first movable base (102) for supporting the pre-bonding workpieces. The first movable base is upwardly movable to move the workpieces out the first container one by one. The second container is near to the first container for containing bonded workpieces. The second container has a second movable base (122) for supporting the bonded workpieces, and the second movable base is downwardly movable to accept more workpieces. The transferring mechanism is for transferring the workpieces out the first container to the second container. The bonding agent supplier is for providing bonding agent on the workpieces by which the workpieces are bonded together.

### BACKGROUND OF THE INVENTION

1. Field of the Invention

The present invention generally relates to cylindrical grinding apparatus and, more particularly, to an apparatus for bonding workpieces to be cylindrically ground, and also relates to a method for bonding the workpieces.

2. Discussion of the Related Art

Usually, optical elements, such as camera lenses and glasses lenses, are in used in cylindrical form. However, original optical workpieces (i.e., lens blanks) are manufactured in the form of a square. Therefore, the original optical workpieces have to be cylindrically ground before use.

A typical example of a contemporary cylindrical grinding apparatus is a centering apparatus. The centering apparatus typically includes a pair of holders for holding the original workpiece, where each holder has a hollow chamber communicating with a surface of the holder. The holder can hold the workpiece on its surface by using an air pump pumping the hollow chamber, a grinding wheel is then used to cylindrically grind the workpiece. However, the centering apparatus can only cylindrically grind one piece of workpiece each time.

Therefore, an apparatus, which can bonding a plurality of workpieces together for cylindrical grinding, is desired.

### SUMMARY OF THE INVENTION

An apparatus for bonding workpieces includes a first container, a second container, a transferring mechanism, and a bonding agent supplier. The first container is for containing pre-bonding workpieces. The first container has a first movable base for supporting the pre-bonding workpieces. The first movable base is upwardly movable to move the workpieces out of the first container one by one. The second container is near to the first container for containing bonded workpieces. The second container has a second movable base for supporting the bonded workpieces, and the second movable base is downwardly movable to accept more workpieces. The transferring mechanism is for transferring the workpieces out of the first container to the second container. The bonding agent supplier is for applying bonding agent to the workpieces by which the workpieces are bonded together.

A method for bonding workpieces, comprising the steps of: receiving a stack of pre-bonding workpieces in a first container; moving an outer pre-bonding workpiece out of the first container; transferring the outer pre-bonding workpiece to a second container for bonding with a previously bonded workpiece; and moving the bonded workpieces in the second container so as to allow the second container to accept another pre-bonding workpiece.

Other advantages and novel features will become more apparent from the following detailed description when taken in conjunction with the accompanying drawings.

### BRIEF DESCRIPTION OF THE DRAWING

Many aspects of the apparatus for bonding workpieces can be better understood with reference to the following drawing. The components in the drawing are not necessarily to scale, the emphasis instead being placed upon clearly illustrating the principles of the present apparatus. Moreover, in the drawing, like reference numerals designate corresponding parts throughout the several views.

FIG. 1 is a schematic view of an apparatus for bonding workpieces in accordance with a preferred embodiment of the present invention.

### DETAILED DESCRIPTION OF THE EMBODIMENT

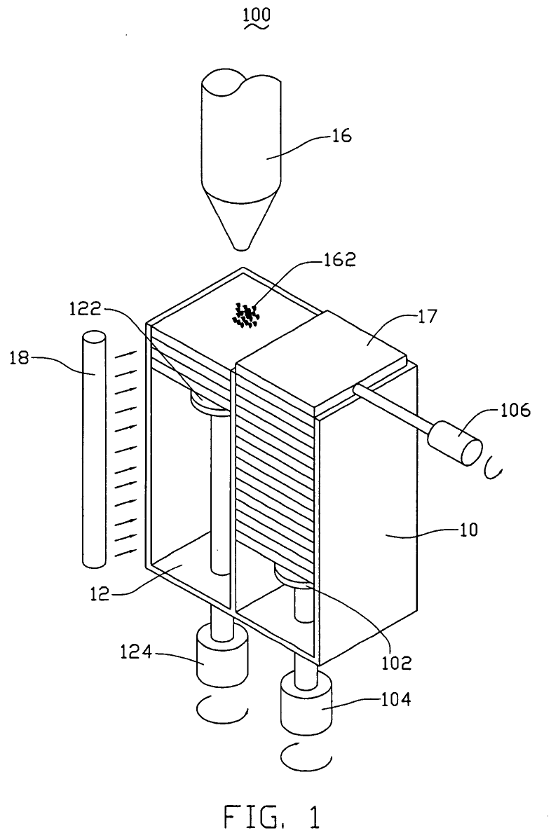

Referring to FIG. 1, in a preferred embodiment, an apparatus 100 for bonding workpieces, includes a first container 10, a second container 12, and a bonding agent supplier 16.

The second container 12 is positioned near to the first container 10. In this embodiment, the first and second containers 10, 12 are integrated with each other. In alternative embodiment, the first and second containers 10, 12 can be separated. Both the first container 10 and the second container 12 have an inside space for containing a number of workpieces 17, possibly in the range of 50-100. The workpieces 17 can be optical elements having a non-cylindrical shape. In this preferred embodiment, the workpieces are in substantially square form. Therefore, the first and second containers 10, 12 are configured to have a square cross section, for compliantly receiving the workpieces therein. Understandably, the inside space of the first and second containers 10, 12 can be other shape depending on the form of the workpieces 17. The first container 10 has a first movable base 102, and the first movable base 102 is connected to a first step motor 104 for controlling the first movable base 102. The second container 12 has a second movable base 122, and the second movable base 122 is connected to a second step motor 124 for controlling the second movable base 122. A transferring mechanism 106 is installed above the first container 10 for transferring the workpieces 17. The transferring mechanism 106 is configured for working in a reciprocating manner, and can be a reversible motor, a spring mechanism, or a bar linkage. A top of the second container 12 is exposed outside.

The bonding agent supplier 16 is disposed above the second container 12. In this embodiment, the bonding agent supplier 16 can be a titration vessel with bonding agent, such as adhesive 162, contained inside. The adhesive 162 can be of any type, including heat-dried, volatilizing, and ultraviolet adhesive.

When the adhesive 162 is ultraviolet adhesive, one side of the second container 12 is exposed to the outside, and an ultraviolet lamp 18 is disposed near to the side of the second container 12 for solidifying the ultraviolet adhesive 162.

Referring to FIG. 1, a method for bonding workpieces 17 by using the apparatus 100, includes the steps of:

(1) placing a stack of workpieces 17 (i.e., pre-bonding workpieces) on the first movable base 102 of the first container 10;

(2) moving the first movable base 102 of the first container 10 upward by using the first step motor 104, making a workpiece 17 out of the top of the first container 10;

(3) transferring the workpiece 17 to the second container 12 by using the transferring mechanism 106;

(4) dropping a predetermined mount of adhesive 162 on a surface of the workpiece 17 from the bonding agent supplier 16;

(5) moving the second movable base 122 of the second container 12 downward by using the second step motor 124, making the workpiece 17 in the second container 12;

(6) transferring another pre-bonding workpiece from the first container 10 to the second container 12, for bonding with the previous workpiece 17;

(7) dropping the adhesive 162 on the surface of the another workpiece for bonding with a further another workpiece;

(8) repeating step (6)-(7) until a predetermined number of workpieces 17 are bonded together.

In the bonding process, the adhesive 162 is applied to two adjacent workpieces 17 by which the two workpieces 17 are bonded together. Therefore, the step (4) can be performed either before or after step (3). That is, the adhesive 162 can alternatively be applied to the workpiece 17 when the workpiece 17 locates in the first container 10. As another option, the adhesive 162 can also be applied to the workpiece 17 while the workpiece 17 is being transfered to the second container 12.

The apparatus 100 can bond a stack of workpieces 17 together in a short time for cylindrical grinding, which can promote the working efficiency of the cylindrical apparatus.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An apparatus for bonding workpieces, comprising:
a first container for containing pre-bonding workpieces, the first container having a first movable base for supporting the pre-bonding workpieces, the first movable base being upwardly movable to move the workpieces out of the first container one by one;
a second container near to the first container for containing bonded workpieces, the second container having a second movable base for supporting the bonded workpieces, the second movable base being downwardly movable to accept more workpieces;
a transferring mechanism for transferring the workpieces from the first container to the second container; and
a bonding agent supplier for providing bonding agent on the workpieces by which the workpieces are bonded together.

2. The apparatus as claimed in claim 1, wherein the bonding agent supplier comprises an adhesive titration vessel containing ultraviolet adhesive therein.

3. The apparatus as claimed in claim 2, wherein the top of the second container is exposed to the outside.

4. The apparatus as claimed in claim 3, wherein the adhesive titration vessel is disposed above the second container.

5. The apparatus as claimed in claim 2, wherein one side of the second container is exposed to the outside, and the apparatus comprises an ultraviolet lamp disposed near to the side of the second container for solidifying the ultraviolet adhesive.

6. The apparatus as claimed in claim 1, wherein the transferring mechanism is workable in a reciprocating manner.

7. The apparatus as claimed in claim 6, wherein the transferring mechanism is selected from the group consisting of a reversible motor, a spring mechanism, and a bar linkage.

8. The apparatus as claimed in claim 1, wherein the apparatus comprises a step motor for controlling movement of each of the first and second movable bases.

9. A method for bonding workpieces, comprising the steps of:
receiving a stack of pre-bonding workpieces in a first container;
moving an outer pre-bonding workpiece out of the first container;
transferring the outer pre-bonding workpiece to a second container for bonding with a previously bonded workpiece; and
moving the bonded workpieces into the second container to allow the second container to accept another pre-bonding workpiece.

10. The method of claim 9, further comprising a step of providing a bonding agent on one of the outer pre-bonding workpiece and the previously bonded workpiece.
